(19) United States
(12) Patent Application Publication
(10) Pub. No.: US 2015/0151658 A1
(43) Pub. Date: Jun. 4, 2015

(54) ADJUSTABLE SEAT COVER

(71) Applicant: Benjamin G. Burris, Jonesboro, AR (US)

(72) Inventor: Benjamin G. Burris, Jonesboro, AR (US)

(21) Appl. No.: 14/093,843

(22) Filed: Dec. 2, 2013

(51) Int. Cl. B60N 2/60; A47C 31/11

(52) U.S. Cl. CPC B60N 2/60; A47C 31/11

(57) ABSTRACT

A cover assembly for use with a chair includes a seat rest and a back rest connected to the seat rest. A pocket is formed within the back rest. A first air bladder is mounted in the first pocket. The first air bladder has a first air chamber. A head rest is connected to the back rest. The head rest has an upper surface and a lower surface that defines an accordion section and a receptacle. A cavity is enclosed between the upper and lower surfaces. A second air bladder is mounted in the cavity. The second air bladder has a second air chamber. An air pump is in fluid communication with the first and second air bladders. The air pump operates to inflate and deflate the first and second air bladders.

### I. TECHNICAL FIELD OF THE INVENTION

This invention relates to chairs and seats and in particular to an adjustable cover for use with a chair or seat.

### II. BACKGROUND OF THE INVENTION

Individual humans have a wide variety of body shapes and sizes. Some are tall and some are short. Some are wide and some are thin. Vehicle seats such as airline seats are installed with only one size and are of limited adjustability.

The height of the top of airline seats is fixed to a pre-determined size by the manufacturer. Unfortunately, for some taller individuals the airline seat may not provide any support for their head during an airline flight.

A search of the prior art did not disclose any patents that read directly on the claims of the instant invention; however, the following references were considered related:

U.S. Pat. No. 5,806,925, issued in the name of Hanley;

U.S. Pat. No. 6,655,735 B1, issued in the name of Learning;

U.S. Pat. No. 5,802,643, issued in the name of Sloot;

U.S. Pat. No. 7,841,658 B1, issued in the name of Marble;

U.S. Pat. No. 5,533,787, issued in the name of Xiang;

U.S. Pat. No. 7,000,984 B1, issued in the name of Ward;

U.S. Pat. No. 5,850,643, issued in the name of Brumfield; and

U.S. Pat. No. 6,217,116 B1, issued in the name of Sloot.

### III. SUMMARY OF THE INVENTION

Example embodiments provide an adjustable seat cover for use with chairs or seats such as an airline seat.

According to one embodiment of the present invention, a cover assembly for use with a chair includes a seat rest and a back rest connected to the seat rest. The back rest has an inner surface and an outer surface. A first pocket is formed within the back rest. A first air bladder is mounted in the first pocket. The first air bladder has a first air chamber. Ahead rest is connected to the back rest. The head rest has an upper surface and a lower surface that defines an accordion section and a receptacle. A cavity is enclosed between the upper and lower surfaces. A second air bladder is mounted in the cavity. The second air bladder has a second air chamber. An air pump is in fluid communication with the first and second air bladders. The air pump operates to inflate and deflate the first and second air bladders. An air tube is coupled between the air pump, the first air bladder and the second air bladder.

### IV. BRIEF DESCRIPTION OF THE DRAWINGS

FIG. 1 illustrates a perspective view of a chair, according to example embodiments.

FIG. 2 illustrates a perspective view of an adjustable seat cover assembly, according to example embodiments.

FIG. 3 illustrates a perspective view of a chair having an adjustable seat cover assembly mounted to the chair showing the headrest in a deflated retracted position, according to example embodiments.

FIG. 4 illustrates a side cross-sectional view of the chair and adjustable seat cover assembly of FIG. 3, according to example embodiments.

FIG. 5 illustrates a perspective view of a chair having an adjustable seat cover assembly mounted to the chair showing the headrest in an inflated extended position, according to example embodiments.

FIG. 6 illustrates a side cross-sectional view of an alternative embodiment of a chair and adjustable seat cover assembly with seat air bladders, according to example embodiments.

### V. DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

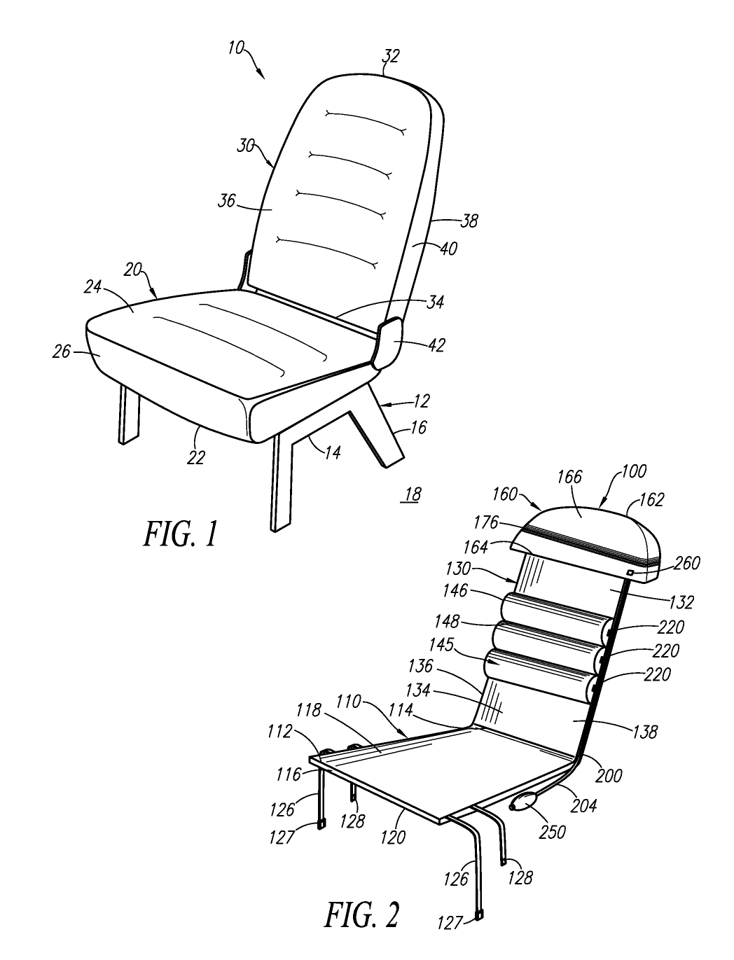

FIG. 1 illustrates a chair or seat 10. Chair 10 can be any suitable type of seat that allows a user to sit thereon. In one embodiment, chair 10 is a vehicle seat such as an airline seat typically provided in commercial airliners for use by airline passengers. Chair 10 includes a frame 12 that has support members 14. Legs 16 extend downwardly from support members 14 terminating in contact with a floor 18. A seat 20 is affixed to support members 14. Seat 20 has a bottom surface 22, a top surface 24 and side surfaces 26. A back support 30 is attached to seat 20. Back support 30 has a top end 32, bottom end 34, front side 36, a back or rear side 38 and sides 40. A pivoting hinge member 42 connects back support 30 to seat 20. Seat 20 and back support 30 can both contain cushioning foam.

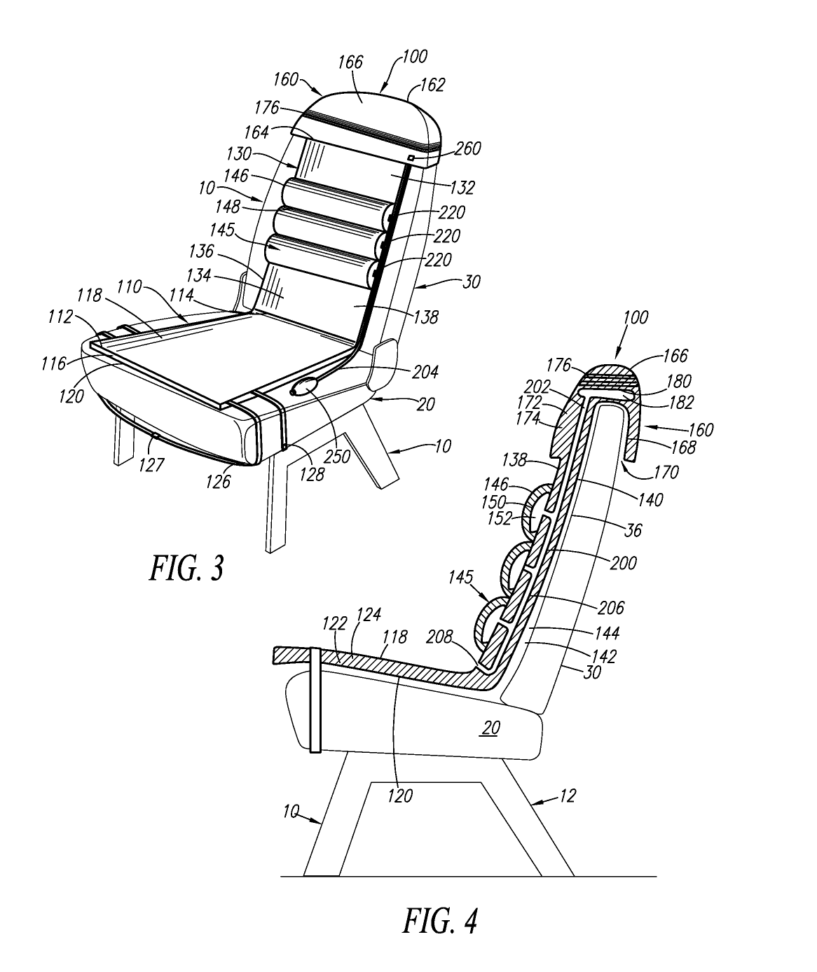

FIG. 2 illustrates an adjustable seat cover assembly 100. FIGS. 3 and 4 illustrate an adjustable seat cover assembly 100 mounted over the chair 10 with the headrest in a deflated retracted position. Referring to FIGS. 2-4, adjustable seat cover assembly 100 comprises a seat rest 110, a back rest 130, a head rest 160, an air tube 200 and an air pump 250.

Seat rest 110 includes a front end 112, a rear end 114, three sides 116, a flexible top surface 118 and a flexible bottom surface 120. In one embodiment, seat rest 110 is generally square or rectangular in shape. A cavity 122 is defined within seat rest 110 between sides 116 and surfaces 118, 120. Cavity 122 is filled with a cushion 124 formed from material such as a resilient foam. One or more straps 126 are attached to seat rest 110. Straps 126 can be attached around the bottom 22 of seat 20 in order to retain adjustable seat cover assembly 100 to chair 10. In one embodiment, straps 126 have a buckle 127 with ends that snap together. In another embodiment, hook and loop fasteners 128 such as VELCRO® are attached to the ends of straps 126.

The back rest 130 includes a top end 132, a bottom end 134, two sides 136, a flexible inner surface 138 and a flexible outer surface 140. In one embodiment, back rest 130 is generally square or rectangular in shape. The back rest 130 is connected to the seat rest 110. Specifically, the bottom end 134 of the back rest is connected to the rear end 114 of the seat rest. A cavity 142 is defined within back rest 130 between sides 136 and surfaces 138, 140. Cavity 142 is at least partially filled with a cushion 144 formed from material such as a resilient foam. Seat rest 110 and back rest 130 can be formed from flexible, pliable materials such as fabric, vinyl, leather, neoprene, plastic or other suitable materials.

A lumber support 145 is formed within back rest 130. Lumbar support 145 includes several pockets 146 formed on surface 138. In one embodiment, pockets 146 are formed by sewing material using seams 148 to separate each of the pockets. In another embodiment, pockets 146 are formed on the backside of surface 138 within cavity 142. In another embodiment, seams 148 join inner surface 138 to outer surface 140 to form pockets 146.

An inflatable air bladder 150 is mounted in each of the pockets 146. The air bladder has an air chamber 152. The air bladder 150 is capable of being inflated and deflated by a fluid such as air. Inflatable air bladder 150 is formed from a flexible material that is impervious to gases such as rubber or vinyl.

A head rest 160 is connected to the top of the back rest 130. The head rest 160 has a top 162, a bottom 164, a concave upper or outer surface 166 and a concave lower or inner surface 168. Inner surface 168 defines a receptacle 170. In one embodiment, head rest 160 is generally semi-circular in shape. The top end 132 of the back rest is connected to the bottom of the head rest 160.

A cavity 172 is defined within head rest 160 between surfaces 166 and 168. Cavity 172 is at least partially filled with a cushion 174 formed from material such as a resilient foam. Head rest 170 can be formed from flexible, pliable materials such as fabric, vinyl, leather, neoprene, plastic or other suitable materials.

Headrest 160 further includes a flexible accordion or bellows section 176. In one embodiment, accordion section 176 is formed from pleated material that can expand and contract. Accordion section 176 is located in surfaces 116 and 168 towards top end 162.

Another inflatable air bladder 180 is mounted in cavity 172 adjacent to the end of receptacle 170. The air bladder 180 has an air chamber 182. The air bladder 180 is capable of being inflated and deflated by a fluid such as air. Inflatable air bladder 180 is formed from a flexible material that is impervious to gases such as rubber or vinyl. An air valve 260 is connected to air bladder 180.

An air hose or air tube 200 has an upper end 202 a lower end 204 and a central section 206. Air tube end 202 is connected to air bladder 180 and provides a fluid communication path for air flow between air tube 200 and bladder 180 when inflating or deflating bladder 30. The central section 206 of air tube 200 is connected to each of the air bladders 150 and provides a fluid communication path for air flow between air tube 200 and each of air bladders 150 when inflating or deflating air bladders 150. The lower end 204 of the air tube 200 extends from an opening 208 of inner surface 138 and is connected to a hand operated inflation mechanism or air pump 250.

Air valves 220 are connected between the air tube 200 and each of the air bladders 150. An air valve 260 is connected between the air tube 200 and air bladder 180. Air valves 220 and 260 provide a fluid communication path for air flow between air tube 200 and each of air bladders 150 and 180 when inflating or deflating air bladders 150. Air valves 220 and 260 can be selectively actuated by a user to allow air to flow into or out of air bladders 150 and 180. Air pump 250 can be operated in conjunction with air valves 220 and 260 to selectively supply and remove pressurized air from air chambers 152 and 182 such that air bladders 150 and 180 can be inflated and deflated by the operation of air pump 250.

The installation and operation of adjustable seat cover assembly 100 will now be described with reference to FIGS. 1-5. The adjustable seat cover assembly 100 is placed over the chair 10 such that the bottom surface 120 of the seat rest 110 sits on the top surface 24 of the seat 20. The outer surface 140 of the back rest 130 is adjacent to the front side 36 of the seat back 30. The top end 32 of the chair 10 is received within receptacle 170 such that the headrest 160 surrounds the top end 32 of the chair 10 with the inner surface 168 surrounding the top end 32 of the chair 70. Strap 126 is fastened around the front side 26 of the seat bottom 20 by using adjustable buckle 127.

The adjustable seat cover user can adjust the height and firmness of the back rest 130 and pockets 146 using air pump 250 and air valves 220. The height and firmness of each of the air bladders 150 is selectively adjustable by the user. The user can depress an air valve 220 and manually squeeze air pump 250 to increase the pressure within a selected one of air bladders 150. The user can depress an air valve 220 in order to release pressure from within one of a selected air bladder 150.

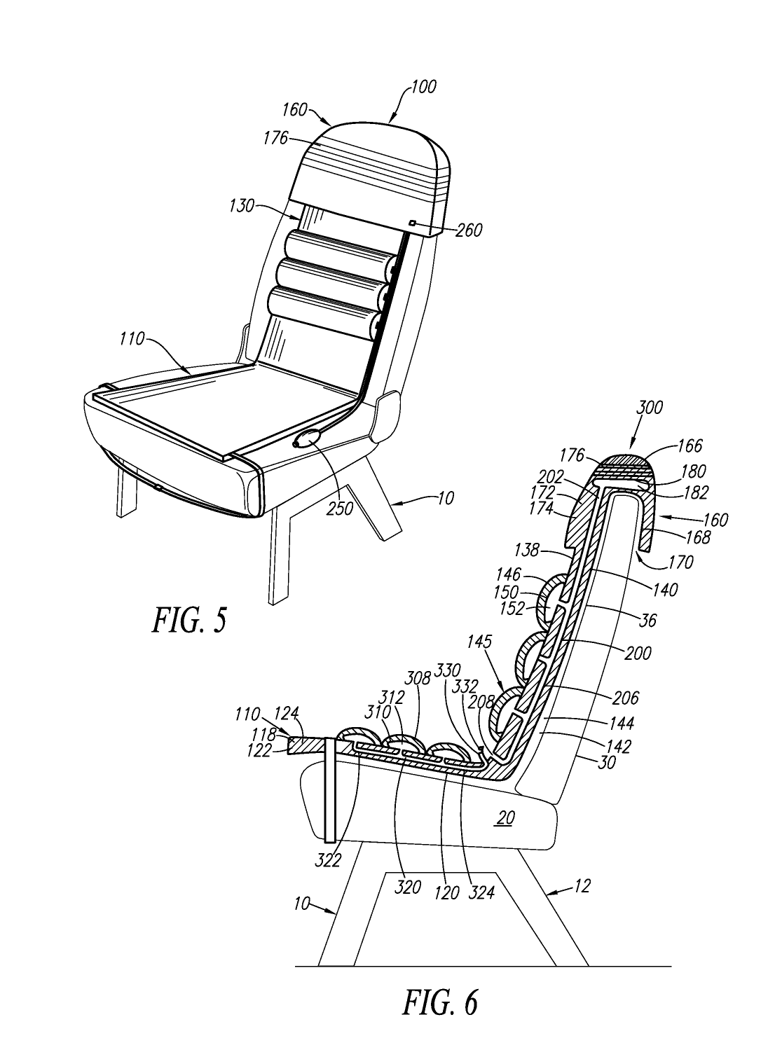

The adjustable seat cover user can adjust the height and firmness of the head rest 160 using air pump 250 and air valve 260. The user can depress air valve 260 and manually squeeze air pump 250 to increase the pressure within air bladder 180. Initially, headrest 160 is in a retracted position as shown in FIG. 3 with the accordion section 176 collapsed. The headrest position in FIG. 3 is suitable for a shorter user such that the head of the user is aligned with the headrest 160. An increase in pressure in air bladder 180 causes the accordion section 176 of head rest 160 to move upwardly increasing the height of headrest 160 as shown in FIG. 4. In FIG. 5, headrest 160 is shown in an extended with the accordion section 176 fully expanded. The headrest position in FIG. 5 is suitable for a taller user such that the head of the user is aligned with the headrest 160. The user can depress air valve 260 in order to release pressure from air bladder 180 causing the accordion section 176 to retract downwardly.

The adjustable seat cover assembly 100 allows a user to adjust the firmness and position of a lumbar support that supports the back of the user. The adjustable seat cover assembly 100 further allows a user to adjust the height and position of a headrest that supports the head of the user.

FIG. 6 illustrates an alternative embodiment of an adjustable seat cover assembly 300. Adjustable seat cover assembly 300 is similar to adjustable seat cover assembly 100 except that adjustable air bladders 310 have been added to seat rest 110. Several pockets 308 are formed on the top surface 118 of seat rest 110. Alternatively, pockets 308 can be formed on the bottom surface 120 of seat rest 110. An inflatable air bladder 310 is mounted in each of the pockets 308. The air bladder 310 has an air chamber 312. The air bladder 310 is capable of being inflated and deflated by a fluid such as air. Inflatable air bladder 310 is formed from a flexible material that is impervious to gases such as rubber or vinyl.

An air hose or air tube 320 has one end 322 that terminates toward the end of seat rest 110 and another end 324 located toward the junction of seat rest 110 and back rest 130. Air tube 320 is connected to each air bladder 310 and provides a fluid communication path for air flow between air tube 320 and bladder 310 when inflating or deflating bladder 310. The end 324 of the air tube 320 is connected to a mouthpiece 330 that extends upwardly away from top surface 118.

Mouthpiece 330 is in fluid communication with air tube 320. A user can place their mouth over mouthpiece 330 and blow air into mouthpiece 330 and by extension air tube 320 and bladder 310 causing air bladders 310 to be inflated. Increasing air pressure within air bladders 310 causes the air bladders 310 to become harder or more rigid.

A stopper 332 is attached to the end of mouthpiece 330. A user can insert stopper 332 into the end of mouthpiece 330 thereby holding pressurized air within air tube 320 and bladders 310. A user can remove stopper 332 from the end of mouthpiece 330 thereby allowing pressurized air within air tube 320 and air bladders 310 to escape and making air bladders 310 softer or less rigid. In one embodiment, mouthpiece 330 can be used with air tube 200 and air pump 250 can be used with air tube 320. Mouthpiece 330 and air pump 250 can be used interchangeably to inflate or deflate air bladders 150 and 310.

It is envisioned that the various embodiments, as separately disclosed, are interchangeable in various aspects, so that elements of one embodiment may be incorporated into one or more of the other embodiments, and that specific positioning of individual elements may necessitate other arrangements not specifically disclosed to accommodate performance requirements or spatial considerations.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A cover assembly for use with a chair, the cover assembly comprising:
a seat rest having a front side, a rear side, a top surface and a bottom surface;
a cushion disposed between the top surface and the bottom surface;
a back rest having a top, a bottom, a first side and a second side, the back rest portion further having an inner surface and an outer surface, the bottom of the back rest connected to the rear side of the seat rest;
a head rest connected to the top of the back rest, the head rest having an upper surface and a lower surface that defines an accordion section and a receptacle;
a cavity enclosed between the upper and lower surfaces;
a first air bladder mounted in the cavity, the first air bladder having a first air chamber; and
an inflation mechanism in fluid communication with the first air bladder, the inflation mechanism operable to inflate and deflate the first air bladder.

2. The cover assembly of claim 1, further comprising:
an air tube having a first end and a second end, the first end coupled to the first air bladder, the air tube in fluid communication with the first air chamber, the second end coupled to the inflation mechanism.

3. The cover assembly of claim 2, further comprising:
a first air valve coupled to the air tube, the first air valve in fluid communication with the air tube and the first air bladder, the first air valve operable to admit and release air from the first air bladder.

4. The cover assembly of claim 2, wherein the accordion section is expanded when the first air bladder is inflated and the accordion section is retracted when the first air bladder is deflated.

5. The cover assembly of claim 1, further comprising:
a pocket formed within the back rest; and
a second air bladder mounted in the pocket, the second air bladder having a second air chamber;
the inflation mechanism in fluid communication with the second air bladder, the inflation mechanism operable to inflate and deflate the second air bladder.

6. The cover assembly of claim 5, wherein the pocket is formed between a pair of seams.

7. The cover assembly of claim 5, further comprising:
an air tube having a first end and a second end, the first end coupled to the second air bladder, the air tube in fluid communication with the second air chamber, the second end coupled to the inflation mechanism.

8. The cover assembly of claim 7, further comprising:
a second air valve coupled to the air tube, the second air valve in fluid communication with the air tube and the second air bladder, the second air valve operable to admit and release air from the second air bladder.

9. A cover assembly for use with a chair, the cover assembly comprising:
a seat rest having a front side, a rear side, a top surface and a bottom surface;
a back rest having a top, a bottom, a first side and a second side, the back rest portion further having an inner surface and an outer surface, the bottom of the back rest connected to the rear side of the seat rest;
a first pocket formed within the back rest;
a first air bladder mounted in the first pocket, the first air bladder having a first air chamber; and
an air pump in fluid communication with the first air bladder, the air pump operable to inflate and deflate the first air bladder.

10. The cover assembly of claim 9, further comprising:
an air tube having a first end and a second end, the first end coupled to the first air bladder, the air tube in fluid communication with the first air chamber, the second end coupled to the air pump.

11. The cover assembly of claim 10, further comprising:
a first air valve coupled to the air tube, the first air valve in fluid communication with the air tube and the first air bladder, the first air valve operable to admit and release air from the first air bladder.

12. The cover assembly of claim 11, further comprising:
a second and third pocket formed within the back rest;
a second and third air bladder mounted in the second and third pockets, the second air bladder having a second air chamber and the third air bladder having a third air chamber.

13. The cover assembly of claim 12, further comprising:
a second and third air valve coupled to the air tube, the second air valve in fluid communication with the air tube and the second air bladder, the second air valve operable to admit and release air from the second air bladder.

14. The cover assembly of claim 9, further comprising:
a head rest connected to the top of the back rest, the head rest having an upper surface and a lower surface that defines an accordion section and a receptacle;
a cavity enclosed between the upper and lower surfaces; and
a fourth air bladder mounted in the cavity, the fourth air bladder having a fourth air chamber;
the air pump in fluid communication with the fourth air bladder, the air pump operable to inflate and deflate the fourth air bladder.

15. The cover assembly of claim 14, wherein the accordion section is expanded when the fourth air bladder is inflated and the accordion section is retracted when the fourth air bladder is deflated.

16. The cover assembly of claim 15, further comprising:
an air tube having a first end and a second end, the first end coupled to the fourth air bladder and the second end coupled the air pump; and
a fourth air valve coupled to the air tube, the fourth air valve in fluid communication with the air tube and the fourth air bladder, the fourth air valve operable to admit and release air from the fourth air bladder.

17. A cover assembly for use with a chair, the cover assembly comprising:
a seat rest;
a back rest connected to the seat rest, the back rest having an inner surface and an outer surface;
at least one pocket formed within the back rest;
a first air bladder mounted in the first pocket, the first air bladder having a first air chamber;
a head rest connected to the back rest, the head rest having an upper surface and a lower surface that defines an accordion section and a receptacle;
a cavity enclosed between the upper and lower surfaces;
a second air bladder mounted in the cavity, the second air bladder having a second air chamber;
an air pump in fluid communication with the first and second air bladder, the air pump operable to inflate and deflate the first and second air bladders; and
an air tube coupled between the air pump, the first air bladder and the second air bladder.

18. The cover assembly of claim 17, further comprising:
a first air valve coupled to the air tube, the first air valve in fluid communication with the air tube and the second air bladder, the first air valve operable to admit and release air from the second air bladder.

19. The cover assembly of claim 17, wherein the accordion section is expanded when the second air bladder is inflated and the accordion section is retracted when the second air bladder is deflated.

20. The cover assembly of claim 17, wherein a strap is connected to the seat rest.
